(19) United States
(12) Patent Application Publication
(10) Pub. No.: US 2006/0071015 A1
(43) Pub. Date: Apr. 6, 2006

(54) Water changeover manifold for beverage dispenser and method

(76) Inventors: Thaddeus M. Jablonski, Palatine, IL (US); Michael J. Scheurich, Elgin, IL (US)

Correspondence Address: PYLE & PIONTEK, 221 N. LASELLE STREET, SUITE 850, CHICAGO, IL, 60601, US

(21) Appl. No.: 11/197,660

(22) Filed: Aug. 4, 2005

Related U.S. Application Data
(60) Provisional application No. 60/598,631, filed on Aug. 4, 2004.

(51) Int. Cl. G01F 11/00

(52) U.S. Cl. 222/1; 222/129.1

(57) ABSTRACT

A system for selectively supplying either a first or second diluent to a beverage dispensing valve is characterized by a manifold having first and second diluent outlet ports. Two different selection fittings plug, one at a time, into the manifold outlet ports. One, a first diluent selection fitting, when plugged into the manifold outlet ports delivers the first diluent from the manifold first diluent outlet port to the beverage valve while simultaneously closing the manifold second diluent outlet port. The other, a second diluent selection fitting, when plugged into the manifold outlet ports delivers the second diluent from the manifold second diluent outlet port to the beverage valve while simultaneously closing the manifold first diluent outlet port. The two selection fittings are keyed to connect with the manifold in one orientation only, so neither can be used to serve the purpose of the other.

This application claims benefit of provisional application Ser. No. 60/598,631, filed Aug. 4, 2004.

### BACKGROUND OF THE INVENTION

The present invention relates generally to beverage dispensers, and in particular to a beverage dispenser that permits convenient switching between supply of carbonated water and plain water to beverage dispensing valves.

It is known in the beverage dispensing art to use combined ice and beverage dispensers that use cold plates to provide heat exchange cooling of various drinks. The ice/beverage dispenser is often contained in a single cabinet, in an upper portion of which is an ice retaining hopper and in a lower portion of which is a cold plate. The cold plate is cooled by a volume of ice that is gravity fed from a lower opening in the hopper into the lower portion of the cabinet and onto and in heat exchange contact with the cold plate. The cold plate, chilled by the ice, in turn provides for heat exchange cooling of beverage liquids flowed through tubing circuits embedded in the cold plate, which beverage liquids include mixing liquids or diluents such as carbonated water and noncarbonated or plain water, as well as beverage syrup concentrates. After passing through the cold plate circuits for being chilled, the beverage liquids are delivered through tubing to post-mix beverage dispensing valves. A carbonated or noncarbonated drink is produced when cooled carbonated or plain water and a beverage syrup concentrate are mixed together and dispensed from a post-mix valve.

An ice/beverage dispenser customarily has four or more, usually eight or more and often ten post-mix beverage dispensing valves for dispensing various beverages. Each post-mix valve is for dispensing a selected drink and the use of several dispensing valves on a beverage dispenser enables a variety of different drinks to be offered. When a post-mix valve is activated to dispense a selected drink, a syrup concentrate for the drink is mixed with either carbonated water when a carbonated drink is to be dispensed or with plain water when a noncarbonated drink is to be dispensed.

Because customers' tastes change, owners of beverage dispensers are often required to change the supplies of beverage syrup concentrate and carbonated and plain water delivered to dispensing valve in odder to provide pew drink flavors or, perhaps, to enable the dispensing of the same drink flavor from more than one dispensing valve. Historically, each post-mix dispensing valve of a beverage dispenser was coupled to a pair of beverage liquid delivery lines, one for concentrate syrup flavoring and the other for either carbonated or noncarbonated water, with each line leading back to a source of the particular beverage liquid. Consequently, reconfiguring a valve to dispense a different beverage required the tedious and often expensive task of reconfiguring the beverage delivery lines through disconnection and appropriate reconnection of lines that were often relatively inaccessible and access to which required considerable disassembly of the beverage dispenser.

To alleviate the problem of reconfiguring individual beverage liquid delivery lines to post-mix valves of a beverage dispenser, mounting assemblies for post-mix dispensing valves have been used. Such mounting assemblies provide two outlets for a valve, one for delivering concentrate beverage syrup to the valve and the other for delivering either carbonated or noncarbonated water. The mounting assemblies conventionally have two inlets, one for being connected to a supply of concentrate beverage syrup and the other for being connected to a supply of diluent consisting of either carbonated or plain water. Because only one inlet is provided for both carbonated and plain water, to change between dispensing carbonated and noncarbonated drinks by a valve still requires disassembly of the beverage dispenser to access the carbonated and noncarbonated water sources and a subsequent resetting of pressure and flow rates when the dispenser is reassembled.

There is a need for a beverage liquid supply arrangement for post-mix beverage dispensing valve that enables quick, convenient and inexpensive interchange of supply to a valve of either carbonated or noncarbonated water without need to disassemble the dispenser and reset pressures and flow rates.

### OBJECTS OF THE INVENTION

An object of the present invention is to provide a system for and method of selectively delivering one of two beverage diluents to each of a plurality of beverage dispensing valves.

Another object is to provide such a system and method in which two different selection fitting are used to couple between carbonated and plain water outlet ports from a manifold and water inlets to beverage dispensing valves to provide, depending upon which selection fitting is used, either carbonated or plain water to individual ones of the beverage valves.

A further object is to provide such a system and method in which a selection fitting for providing carbonated water to a beverage valve cannot be used to provide plain water to the valve, and in which a selection fitting for providing plain water to a beverage valve cannot be used to provide carbonated water to the valve.

### SUMMARY OF THE INVENTION

In accordance with the present invention, a system for selectively supplying first and second diluents to a beverage dispensing valve comprises a manifold having first and second inlets for fluid coupling to sources of the first and second diluents and respective first and second outlet ports for the diluents. Also included is a first diluent selection fitting for coupling to the manifold first and second diluent outlet ports and to the beverage dispensing valve for delivering the first diluent from the first outlet port to the valve while dosing the second outlet port; and a second diluent selection fitting for coupling to the manifold first and second diluent outlet ports and to the beverage dispensing valve for delivering the second diluent from the second outlet port to the valve while closing the first outlet port.

The system advantageously includes means for constraining the first and second diluent selection fittings for coupling to the manifold in one orientation only. In addition, the first diluent selection fitting may be configured to have a passage and a plug such that, when the first fitting is coupled with the manifold first and second outlet ports, the plug doses the second outlet port and the passage extends between an inlet to the passage at the first outlet port and an outlet from the passage for being fluid coupled to the beverage dispensing valve. In turn, the second diluent selection fitting may be configured to have a passage and a plug such that, when the second fitting is coupled with the manifold first and second outlet ports, the plug doses the first outlet port and the passage extends between an inlet to the passage at the second outlet port and an outlet from the passage for being fluid coupled to the beverage dispensing valve.

It is contemplated that the configuration of the first diluent selection fitting be such that it include a body, first and second dole fittings on one side of the body and a third dole fitting on an opposite side of the body, the second dole fitting comprising a plug and the passage extending between the first and third dole fittings, such that the first and second dole fittings are respectively received in the manifold first and second outlet ports when the first selection fitting is coupled to the manifold outlet ports, with the third dole fitting then providing means for coupling the passage outlet with the beverage valve. In turn, it is contemplated that the configuration of the second diluent selection fitting be such that it include a body, first and second dole fittings on one side of the body and a third dole fitting on an opposite side of the body, the first dole fitting comprising a plug and the passage extending between the second and third dole fittings, such that the first and second dole fittings are respectively received in the manifold first and second outlet ports when the second selection fitting is coupled to the manifold outlet ports, with the third dole fitting then providing means for coupling the passage outlet with the beverage valve.

For convenience in mounting the beverage valve, the system may include a mounting block for mounting the beverage valve, the mounting block having a passage having an outlet for coupling with a diluent inlet to the beverage valve and an inlet for receiving the third dole fitting of one of the first and second diluent selection fittings. Where the beverage valve is part of a beverage dispenser having a beverage panel, the manifold is on a rearward side of the beverage panel, the mounting block is on a forward side of the beverage panel, and one of the first and second fittings extends through an opening in the beverage panel between the manifold and mounting block.

In the preferred embodiment, the system selectively supplies first and second diluents to individual ones of a plurality of beverage dispensing valves. In this case, the system comprises a manifold having first and second diluent inlets for fluid coupling to supplies of first and second diluents and a plurality of pairs of first and second diluent outlet ports respectively fluid coupled to the first and second diluent inlets. Included are a plurality of first diluent selection fittings, each for coupling to a selected individual one of the pairs of first and second diluent outlet ports and for fluid coupling to an associated beverage dispensing valve for delivering the first diluent from the first outlet port of the selected pair of outlet ports to the associated beverage valve while closing the second diluent outlet port of the selected pair of outlet ports; and a plurality of second diluent selection fittings each for coupling to a selected individual one of the first and second diluent outlet ports to which first diluent selection fittings are not coupled and for fluid coupling to an associated beverage dispensing valve for delivering the second diluent from the second outlet port of the selected pair of outlet ports to the associated beverage valve while closing the first diluent outlet port of the selected pair of outlet ports.

The invention also contemplates a method of selectively supplying first and second diluents to a beverage dispensing valve. The method comprises the steps of connecting first and second diluent supplies to a manifold; flowing the first and second diluents through the manifold to respective first and second diluent outlet ports from the manifold; delivering a selected one of the first or second diluents to the beverage dispensing valve by either coupling a first diluent selection fitting to the manifold first and second outlet ports to dose the second outlet port and to establish at least a portion of a flow path for flow of the first diluent from the first outlet port to an inlet to the beverage dispensing valve; or by coupling a second diluent selection fitting to the manifold first and second outlet ports to dose the first outlet port and to establish at least a portion of a flow path for the second diluent from the second outlet port to the inlet to the beverage dispensing valve.

It is contemplated that the step be included of constraining each of the first and second diluent selection fittings for coupling to the manifold in one orientation only.

It also is contemplated that the first diluent selection fitting have a passage and a plug and that the step of coupling the first selection fitting to the manifold first and second outlet ports comprises coupling the plug with the second outlet port to dose the second outlet port and coupling an inlet to the passage to the first outlet port for flow of the first diluent from the first outlet port through the passage, with the passage providing at least the portion of the flow path for the first diluent from the first outlet port to the beverage dispensing valve. It also is contemplated that the second diluent selection fitting have a passage and a plug and that the step of coupling the second selection fitting to the manifold first and second outlet ports comprises coupling the plug with the first outlet port to close the first outlet port and coupling an inlet to the passage to the second outlet port for flow of the second diluent from the second outlet port through the passage, with the passage providing at least the portion of the flow path for the second diluent from the second outlet port to the beverage dispensing valve.

To facilitate coupling with the beverage dispensing valve, the method further contemplates providing a mounting block; mounting the beverage dispensing valve on the mounting block, the mounting block having a passage having an inlet and an outlet; fluid coupling the mounting block passage outlet to a diluent inlet to the beverage dispensing valve, and fluid coupling an outlet from the passage of one of the first and second diluent selection fittings to the mounting block passage inlet for flow of one of the first and second diluents through the mounting block passage and to the diluent inlet to the beverage valve. Connecting each of a first and second diluent supply to the manifold may comprise connecting each of a carbonated and plain water supply to the manifold.

In a preferred practice the method selectively supplies first and second diluents to each of a plurality of beverage dispensing valves. In this case, included are the steps of fluid coupling first and second diluent supplies to respective first and second diluent inlets to a manifold having a plurality of pairs of first and second diluent outlet ports respectively fluid coupled to the first and second diluent inlets; and selectively delivering either the first or second diluent to each of at least two beverage dispensing valves by, in connection with each of the at least two beverage dispensing valves, either coupling a first diluent selection fitting to an associated pair of manifold first and second outlet ports to dose the second outlet port and to establish at least a portion of a flow path for the first diluent from the first outlet port to an inlet to one of the at least two beverage dispensing valves; or coupling a second diluent selection fitting to the associated pair of manifold first and second outlet ports to close the first outlet port and to establish at least a portion of a flow path for the second diluent from the second outlet port to an inlet to the one of the at least two beverage dispensing valves.

Other objects, advantages and features of the invention will become apparent upon a consideration of the following description thereof, when taken in conjunction with the accompanying drawings.

### BRIEF DESCRIPTION OF THE DRAWINGS

FIG. 1 is a perspective view of a combination ice and beverage dispenser of a type with which the teachings of the present invention may advantageously be used;

FIG. 2 is a partial cross-sectional side elevation view of the dispenser of FIG. 1;

FIG. 3 is a schematic of an ice/beverage dispenser and its fluid circuits in accordance with the present invention;

FIG. 4 is a perspective assembly view of a manifold and manifold diluent selection fittings in accordance with the present invention, for selecting either carbonated or noncarbonated water for supply to individual ones of a plurality of post-mix beverage dispensing valve of the dispenser of FIG. 1;

FIGS. 5A and 5B are perspective views of a pair of manifold diluent selection fittings for connection with the manifold, one structured to provide carbonated water to an associated beverage valve and the other structured to provide noncarbonated water to an associated valve;

FIG. 6 is a perspective assembly view showing the manner of mounting the manifold and diluent selection fittings on the beverage dispenser;

FIG. 7 is a front elevation view of a beverage valve mounting block;

FIG. 8 is a cross-sectional side elevation view showing the manner of connection of a diluent selection fitting to the manifold and valve mounting block and the mounting of the same on a beverage panel of the dispenser, and

FIG. 9 is a perspective assembly view showing the invention in use to selectively deliver carbonated or noncarbonated water to ten post-mix beverage dispensing valves.

### DETAILED DESCRIPTION

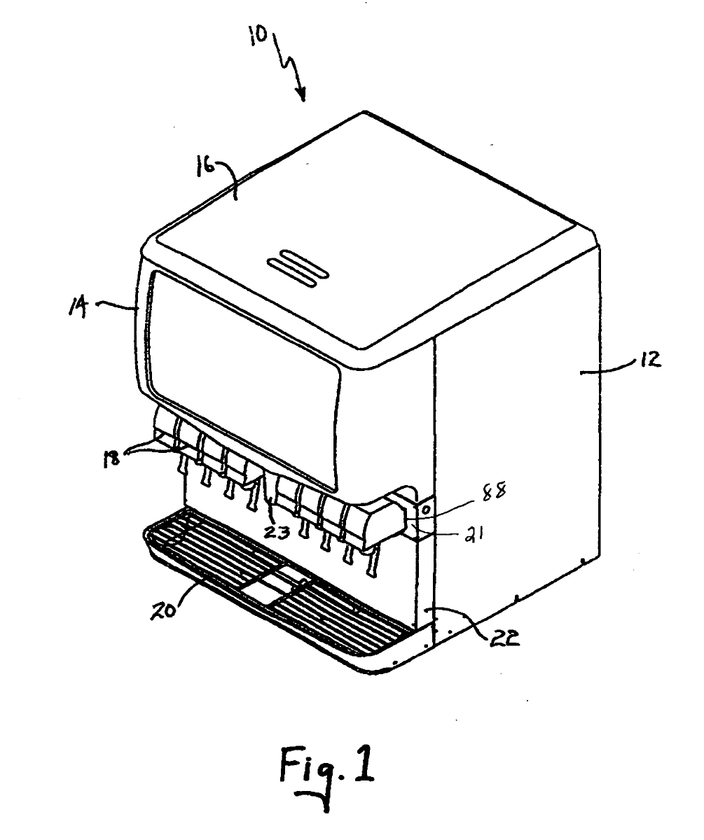

The present invention provides an improved system for connection of post-mix beverage dispensing valves of a beverage dispenser to supplies of carbonated and noncarbonated water, which enables either carbonated or noncarbonated water to easily and conveniently be selected and deselected for delivery to individual ones of the valves. The beverage dispenser may be a combination ice and beverage dispenser of the general type shown in FIG. 1 and indicated generally at 10, and as is conventional includes an outer housing 12, a merchandising cover 14 and a removable ice bin cover 16. A plurality of post-mix beverage dispensing valves 18, eight as shown, are secured to a front surface of the ice/beverage dispenser above a drip tray 20 and adjacent to a beverage panel 21 above splash plate 22. An ice dispensing chute 23 is secured to the front surface of the dispenser medially of the beverage dispensing valves and above the drip tray.

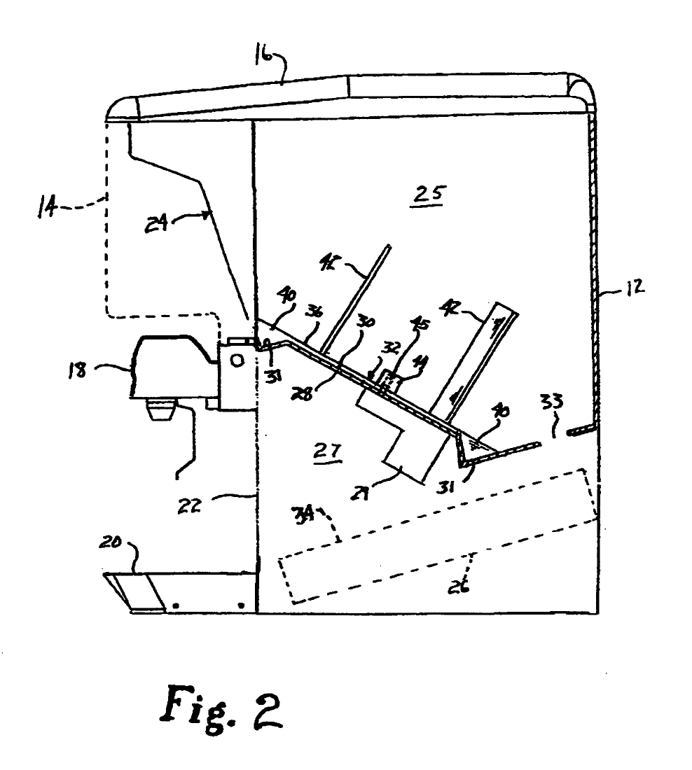

With reference to FIG. 2, the ice/beverage dispenser 10 also includes an ice hopper or ice bin 24 defining within the housing 12 an ice retaining compartment 25. A cold plate 26 is mounted in a cold plate compartment 27 beneath the bin 24 and the bin has a front wall 28 on a lower surface of which is mounted an agitator drive motor 29. An upper surface 30 of the wall, opposite from the agitator drive motor, is configured to define an annular ice directing trough 31. The drive motor 29 serves to rotate an ice dispense agitator or auger, indicated generally at 32, in and through a mass of ice pieces retained in the bin 24. The agitator mixes and agitates the mass of ice in the bin to prevent congealing and agglomeration of the ice pieces into a solid mass of ice and also serves to move ice pieces through the bin trough 31 to and through an outlet opening (not shown) from the bin and into the ice chute 23 for gravity dispensing of the ice out of a lower end of the chute and into a cup. Rotation of the agitator 32 also causes some of the ice pieces in the bin 24 to fall through a bottom bin opening 33 into the lower compartment 27 onto and in heat exchange relationship with a top surface 34 of the cold plate 26. The agitator has a plurality of radially extending ice sweeping arms 36 at outer ends of which are ice paddles 40 that extend into the trough 31 to move ice pieces in the trough to and through the ice outlet from the bin. The agitator also has a plurality of ice agitating blades 42 extending generally perpendicular from the ice sweeping arms 36 for breaking up the mass of ice in the bin into discrete pieces of ice, as well as a drive bushing 44 that accommodates mounting of the agitator to an agitator motor output shaft 45 for rotation of the agitator in the bin.

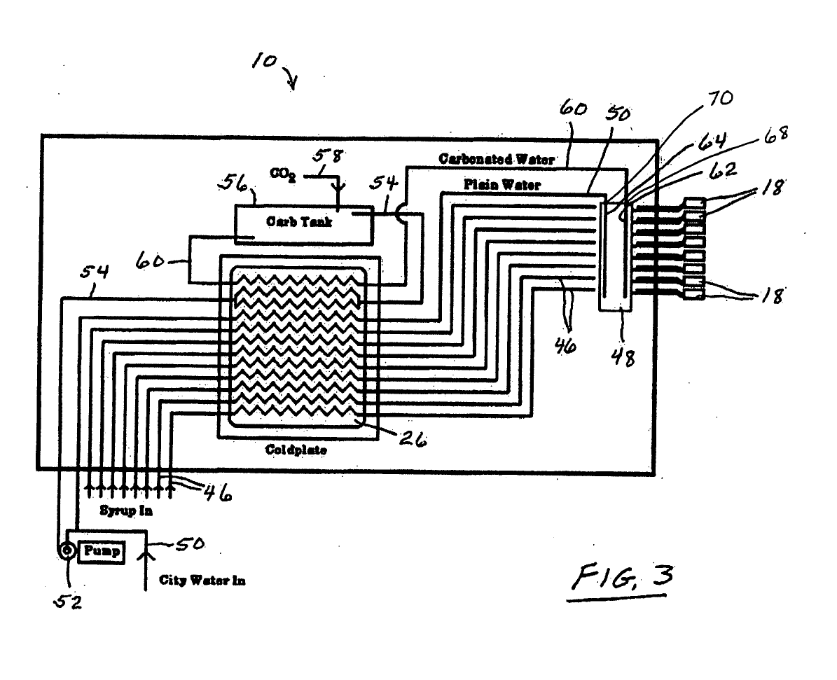

FIG. 3 shows the beverage liquid circuits of the ice/beverage dispenser 10. Eight syrup concentrate flavoring lines 46, one for each of the eight post-mix beverage dispensing valves 18, connect to associated supplies of beverage syrup concentrate (not shown) and from the supplies extend through associated circuits embedded in the cold plate 26 to the dispensing valves. A water line 50, which at its inlet connects to a source of potable water such as city water, also extends through an associated circuit in the cold plate 26 to a manifold 48. The water line 50 also leads to a motor driven pump 52, an outlet line 54 from which extends through a pair of associated circuits in the cold plate 26 to a water inlet to a carbonator 56. The carbonator receives carbon dioxide gas through a line 58 and operates in a well known manner to provide carbonated water at an outlet line 60 that extends through an associated circuit in the cold plate 26 to the manifold 48. At the manifold 48 the carbonated water line 60 connects to an inlet to and supplies carbonated water through a carbonated water distribution tube 62 extending through the manifold and the plain or non-carbonated water line 50 connects to an inlet to and supplies plain noncarbonated water through a noncarbonated water distribution tube 64 extending through the manifold. The post-mix beverage dispensing valves 18 are fluid coupled to associated individual ones of the beverage syrup lines 46 for receiving selected syrup concentrate flavorings. The dispensing valves 18 are also individually fluid coupled to the manifold 48 for receiving either carbonated or noncarbonated water. As will be described, diluent selection fittings used with the manifold enable individual ones of the beverage dispensing valves 18 to easily, quickly, economically and selectively have their water connection to the manifold changed from carbonated water to noncarbonated water, and vice versa.

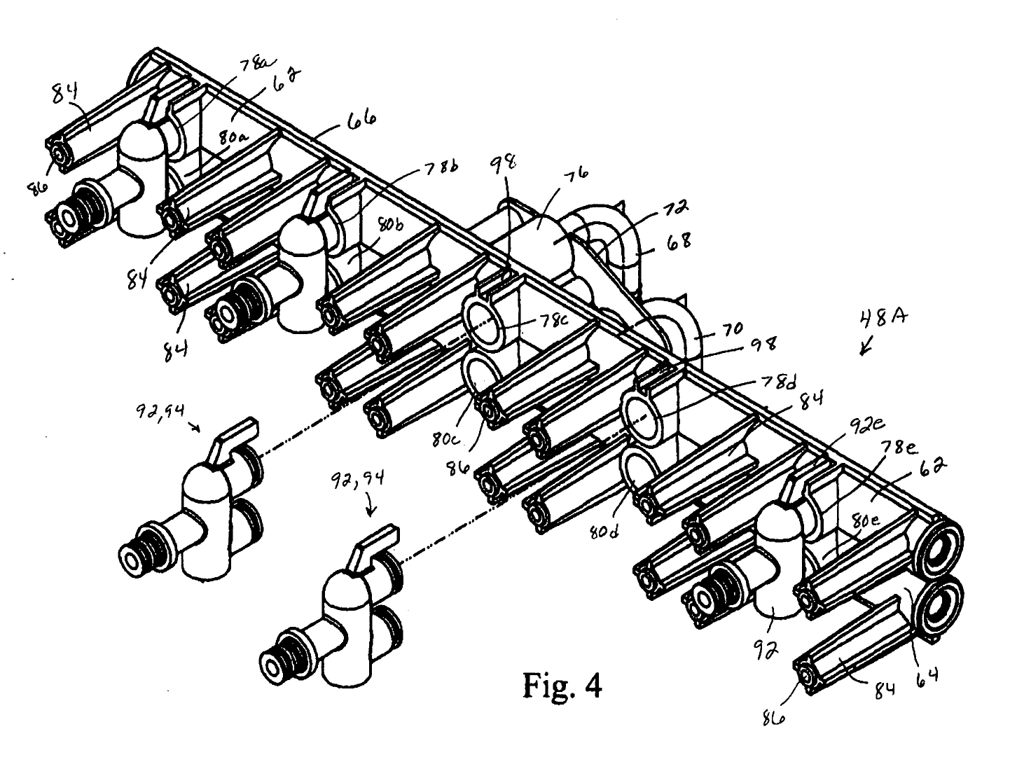

A contemplated configuration of the manifold is shown in FIG. 4 and indicated generally at 48A. The manifold 48A is sized to service five postfix beverage dispensing valves 18, although it could be sized to service a greater or lesser number of valves. The manifold 48A advantageously is an injection molded assembly, such that a main body portion 66 of the manifold comprises a unitary structure and the carbonated water distribution tube 62 and the noncarbonated or plain water distribution tube 64 extend longitudinally along the length of the manifold in parallel and spaced relationship. The plain water delivery line 50 and the carbonated water delivery line 60 terminate in respective water supply fittings 70 and 68 that are received in a plate 72 that is attached by fasteners to a water inlet housing 76 of the manifold 48A. The water inlet housing 76 has passages (not shown) that provide fluid connection between the carbonated water inlet fitting 68 and the manifold carbonated water distribution tube 62 and between the plain water inlet fitting 70 and the manifold plain water distribution tube 64, whereby the tube 62 is fluid coupled to a supply of chilled carbonated water and the tube 64 is fluid coupled to a supply of chilled noncarbonated water. Opposite ends of the carbonated and plain water distribution tubes 62 and 64 are closed.

The manifold 48A is configured to serve five beverage dispensing valves 18 and, therefore, in accordance with the teachings of the invention includes five carbonated water outlet ports, tubes or passages 78a-78e and five plain water outlet ports, tubes or passages 80a-80e on a front side of the manifold. The outlet ports 78a-78e for delivering carbonated water are longitudinally spaced along and in fluid connection at inner ends with the carbonated water distribution tube 62. The outlet ports 80a-80e for providing plain or noncarbonated water are, in turn, longitudinally spaced along and in fluid connection at inner ends with the plain or still water distribution tube 64. Each carbonated water outlet port 78a-78e is vertically spaced above an associated plain water outlet port 80a-80e, thereby to define five pairs of vertically aligned carbonated and noncarbonated water outlet ports, with one water outlet port 78a-78e of each pair providing carbonated water and the other outlet port 80a-80e providing plain water. The outlet ports are tubular and the axes of all of the ports are parallel.

Prior to considering the manner of selecting and deselecting carbonated or plain water for delivery to individual ones of the post-mix beverage dispensing valves by means of fluid coupling diluent selection fittings to the manifold 48A, mounting of the manifold on the ice/beverage dispenser 10 will first be considered. A front side of the manifold 48A includes a plurality of parallel and vertically and longitudinally spaced pairs of standoffs 84 that extend forward from the carbonated and plain water distribution tubes 62 and 64 for mounting and supporting the manifold on a rear or inner side of the dispenser beverage panel 21. Four standoffs 84 are associated with and around each vertically aligned pair of water outlet ports 78a-e and 80a-e, such that an associated pair of standoffs is on each side of each pair of water outlet ports, and forward ends of the standoffs have threaded passages 86. A plurality of back blocks or valve mounting blocks 88 are provided and each accommodates convenient mounting and dismounting of an associated post-mix beverage dispensing valve 18 to and from the dispenser 10 in a known manner. With the manifold positioned on the rear side of the beverage panel 21 such that outer ends of its standoffs 84 are against the beverage panel, five valve mounting blocks 88 are positioned on a front side of the beverage panel over associated pairs of water outlets 78a-78e and 80a-80e, such that fastener receiving passages in the valve mounting blocks and in the beverage panel are aligned with the threaded passages 86 in the manifold standoffs 84. Fasteners 90 are then extended through the aligned passages in the valve mounting blocks 88 and beverage panel 21 into the threaded passages 86 in the manifold standoffs 84 to attach the valve mounting blocks and manifold to the beverage panel with the beverage panel captured therebetween.

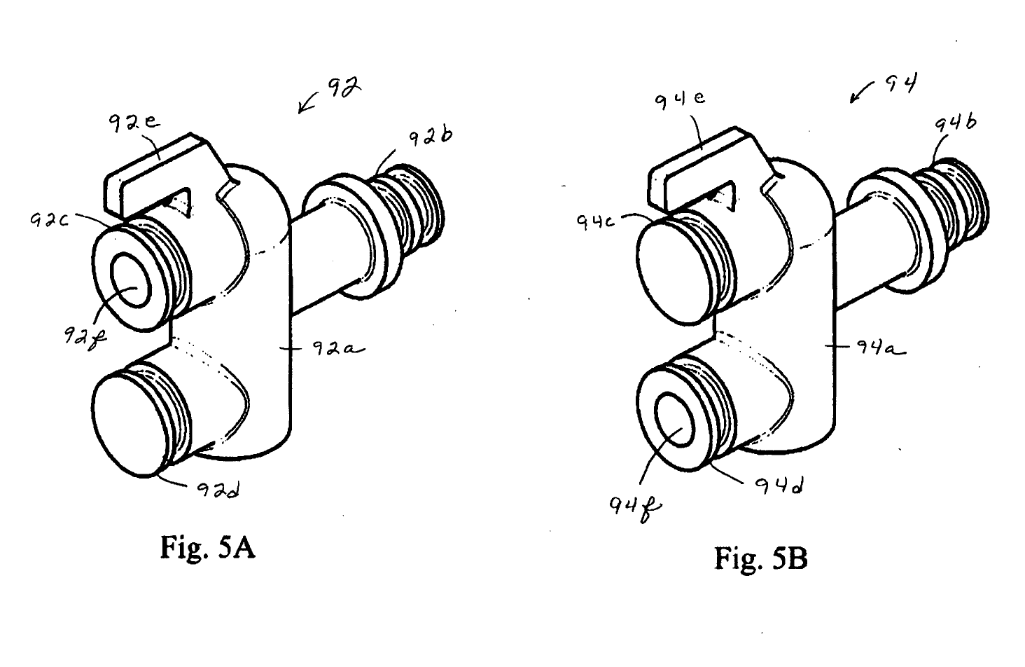

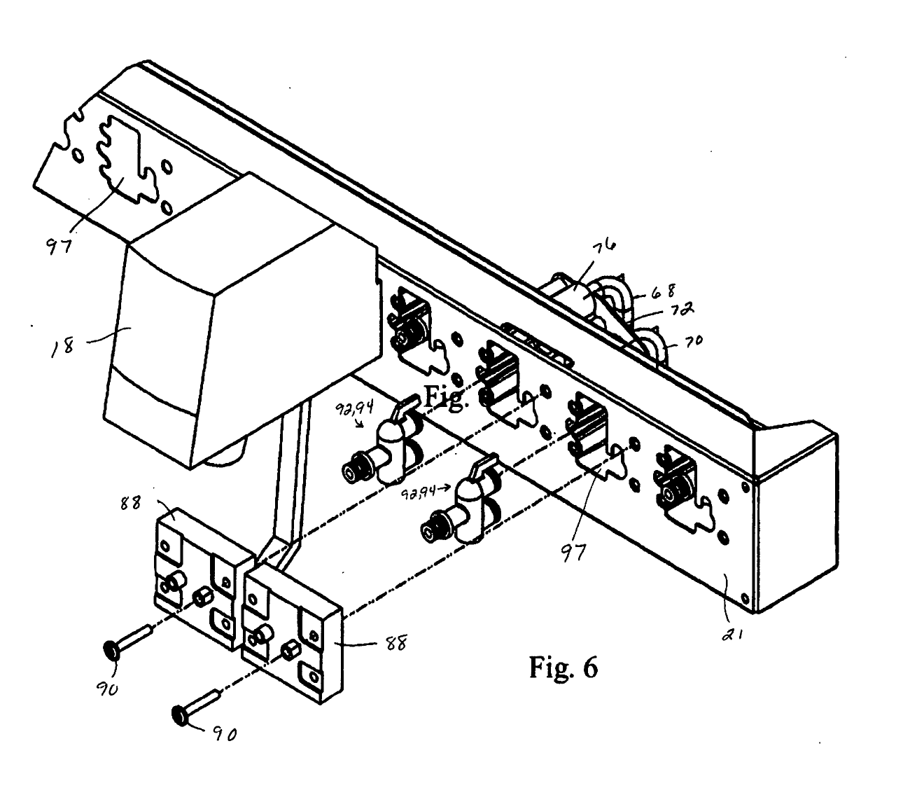

In accordance with the invention, a diluent inlet to each valve mounting block 88 is selectively fluid coupled by either a carbonated water selection fitting 92 to the carbonated water outlet port 78a-78e of an associated pair of water outlet ports, or by a plain or noncarbonated water selection fitting 94 to the plain or noncarbonated water outlet port 80a-80e of the associated pair of water outlet ports, to thereby receive and deliver either carbonated or plain water to the post-mix beverage dispensing valve 18 carried by the mounting block. As best seen in FIGS. 5A and 5B, the carbonated and noncarbonated water selection fittings 92 and 94 have substantially identical external geometries. Each has a respective generally cylindrical body portion 92a and 94a, an extension on one side of the cylindrical body terminating in respective dole fittings 92b and 94b, a pair of extensions on an opposite side of the cylindrical body terminating in respective pairs of dole fittings 92c, 92d and 94c, 94d, and respective keying tabs 92e and 94e on top of the cylindrical extensions and extending over associated upper dole fittings 92c and 94c. The keying tabs 92e and 94e serve to key the water selection fittings 92 and 94 to the manifold 48A, so that they can be plugged into the manifold in one orientation only. O-ring seals (not shown) are received in annular grooves provided in each of the dole fittings.

While externally geometrically similar, a difference between the carbonated and plain water fittings 92 and 94 resides in their internal geometries, and in particular in the path taken by a water conveying passage extending through each fitting. In the carbonated water selection fitting 92, a water conveying passage 92f extends through the fitting from an inlet to the passage at the outer end of the upper dole fitting 92c to an outlet from the passage at an outer end of the dole fitting 92b, while the outer end of the lower dole fitting 92d is dosed. On the other hand, in the plain water fitting 94, a water conveying passage 94f extends through the fitting from an inlet to the passage at an outer end of the lower dole fitting 94d to an outlet from the passage at an outer end of the dole fitting 94b, while the outer end of the upper dole fitting 94c is dosed. As a result of this difference in geometries, when the carbonated water selection fitting 92 is plugged into an associated pair of manifold water outlet ports 78a-78e and 80a-80e, its passage 92f is fluid coupled with and open to the carbonated water distribution tube 62 and dosed to the plain water distribution tube 64, and when the plain water selection fitting 94 is plugged into an associated pair of manifold water outlet ports 78a-78e and 80a-80e, its passage 94f is fluid coupled with and open to the plain water distribution tube 64 and closed to the carbonated water distribution tube 62. Therefore, depending upon which water selection fitting 92 or 94 is used to fluid connect a valve block 88 to the manifold 48A, the postfix beverage dispensing valve 18 carried by the valve block will be selectively supplied with a diluent consisting of either carbonated water or plain water. It is to be appreciated that because of the keying tabs 92e and 94e carried by the carbonated and plain water selection fittings 92 and 94, which are received in keying tab receiving channels 98 provided on upper ends of the carbonated water outlet ports 78a-78e from the tube 62, the selection fittings 92 and 94 may each be plugged into the manifold 48A in one orientation only, i.e., with the keying tabs up. Because of the keying tabs, it is not possible to vertically invert or horizontally rotate one of the fittings 92 and 94 to serve the purpose of the other, e.g., a carbonated water selection fitting 92 cannot be oriented so that its water inlet dole fitting 92c is toward the bottom, thereby to serve the purpose of the plain water fitting 94, since in that orientation of the fitting 92 its keying tab 92e is downward and the fitting 92 cannot be successfully plugged into the manifold 48A because of an interference that would then exist between the keying tab and a lower plain water outlet port 80a-80e from the tube 64.

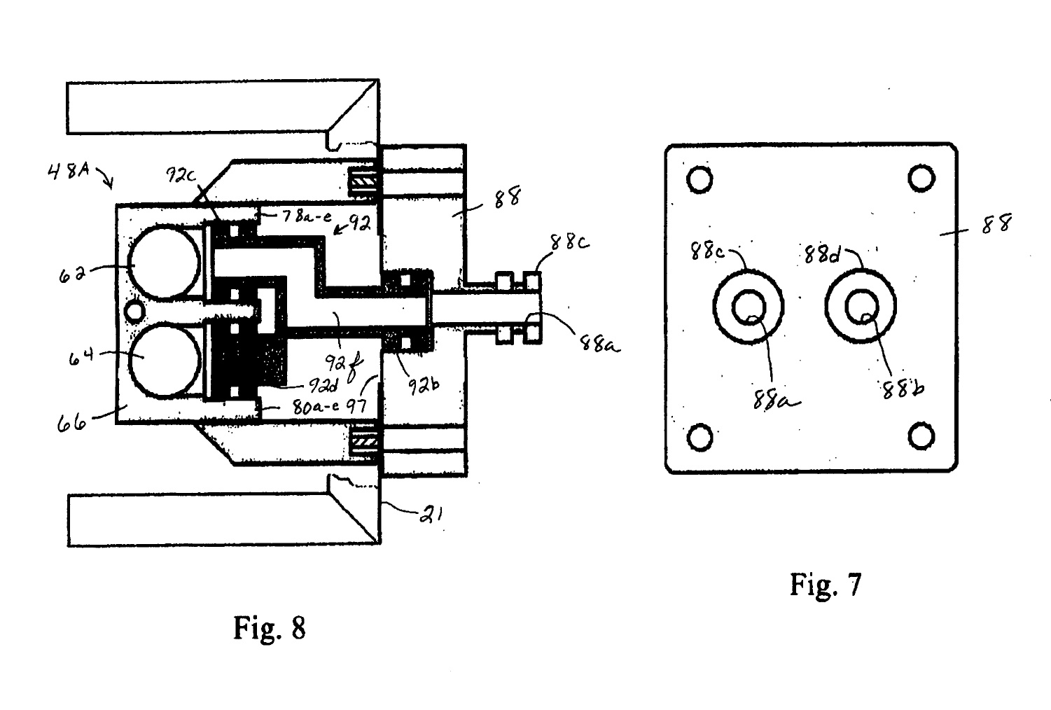

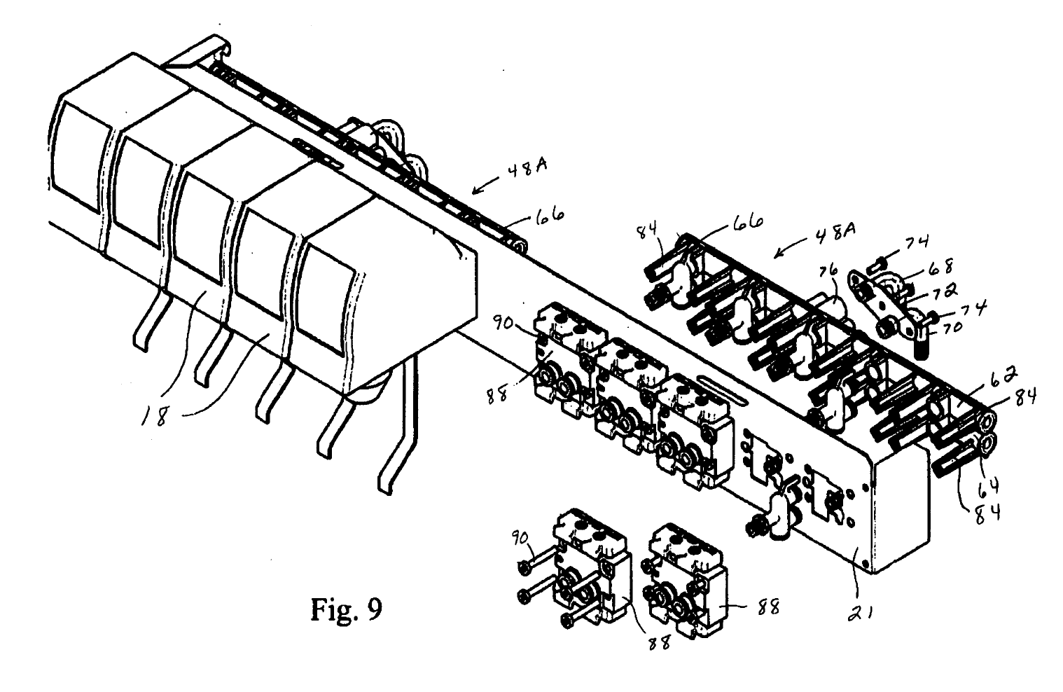

From FIGS. 7 and 8, it is seen that each valve mounting block 88 has a pair of longitudinally spaced passages 88a and 88b that extend through the block and terminate at outlets from the passages in respective dole fittings 88c and 88d on a beverage dispensing valve mounting side of the block. As is known, a post-mix beverage dispensing valve 18 that is carried by a valve mounting block 88 has a pair of fluid inlet passages that receive and fluid couple with the mounting block dole fittings 88c and 88d, so that the beverage valve is provided with chilled water through the mounting block passage 88a and chilled flavored beverage syrup through the mounting block passage 88b, the flavored syrup arriving at the passage 88b through an associated syrup line 46. To determine whether the chilled water connected to the beverage dispensing valve 18 is carbonated or plain water, a choice is made between use of a carbonated water selection fitting 92 and a plain water selection fitting 94 to fluid connect the valve mounting block passage 88a to the manifold 48A. If carbonated water is to be delivered to the beverage dispensing valve, then as seen in FIG. 8, a carbonated water selection fitting 92 is used to fluid couple the manifold carbonated water distribution tube 62 to the valve mounting block fluid passage 88a. In this case, with the valve block 88 removed from the beverage panel 21, a carbonated water selection fitting 92 is extended through an opening 97 in the panel to insert the dole fittings 92c and 92d of the selection fitting 92 into an associated pair of manifold carbonated and plain water outlet ports 78a-78e and 80a-80e, with the keying tab 92e ensuring proper orientation of the selection fitting by being extended into and received in the associated channel 98. The mounting block is then reattached to the beverage panel with the dole fitting 92b of the selection fitting being received in an inlet to the valve block passage 88a. The carbonated water selection fitting 92 then fluid couples the carbonated water distribution line 62 to the valve mounting block passage 88a through the selection fitting passage 92f, while at the same time the closed dole fitting 92d of the selection fitting closes the outlet from the manifold water distribution tube 64. If plain water is to be supplied to the beverage valve, then a plain water selection fitting 94 is plugged into an associated pair of manifold water outlet ports 78a-e and 80a-e, in which case the selection fitting passage 94f then fluid couples the manifold plain water distribution tube 64 to the valve block passage 88a while at the same time the dosed dole fitting 94c of the selection fitting closes the outlet port from the carbonated water line 62.

It is to again be noted that while the selection fittings 92 and 94 are superficially similar, by virtue of the keying tabs 92e and 94e on the selection fittings and the keying tab receiving channels 98 on the manifold 48A, a carbonated water selection fitting 92 cannot be used to deliver plain water to a beverage valve and a plain water selection fitting 94 cannot be used to deliver carbonated water to a valve. Thus, a selection fitting 92 cannot be substituted for a selection fitting 94 simply by rotating the fitting 92 through 180° and then plugging it into the manifold, and vice versa. Instead, the selection fittings can be plugged into the manifold in one orientation only, i.e., with the keying tab up. To deliver carbonated water to a beverage dispensing valve, a fitting 92 must be used, while to deliver plain water to a valve, a fitting 94 must be used. It simply is not possible to accidentally use a carbonated water selection fitting 92 to deliver plain water to a beverage valve or to accidentally use a plain water selection fitting 94 to deliver carbonated water to a beverage valve, so accidental delivery of the wrong diluent to a beverage dispensing valve is avoided. For convenience in identifying between the two visually similar selection fittings 92 and 94, it is contemplated that each be distinctly color coded.

It is to be appreciated that the selection fittings 92 and 94 accommodate quick and convenient selective supply and change of supply of carbonated and plain water diluent to any particular post-mix beverage dispensing valve(s) 18. This is accomplished simply by shutting off the water supply and the syrup flavoring(s) to the particular beverage valve(s), relieving internal system fluid pressures, removing the affected beverage dispensing valve(s) and then removing the associated valve mounting block(s) 88 to access the associated selection fitting(s) 92 and/or 94 through the opening(s) 97 in the beverage panel 21. The selected fitting(s) 92 and/or 94 can then easily be removed from the manifold simply by being physically pulled from the associated pair(s) of manifold water outlet port(s) 78a-78e and 80a-80e, whereupon the desired selection fitting(s) may be plugged into the manifold water outlet ports. For example, if a beverage valve were receiving carbonated water via a fitting 92 and it is desired to deliver plain water to the valve, upon removal of the fitting 92, a fitting 94 would be inserted in its place. After changing the selection fitting(s), the valve mounting block(s) and beverage valve(s) are reassembled on the dispenser 10.

While not shown for clarity, the manifold assembly is insulated on all sides to limit “casual” ambient thermal effects on the temperature of the beverages dispensed. A minimum of ½″ of insulation, either foam or Styrofoam, can be used to insulate all sides of the manifold assembly.

As is appreciated, the invention provides a system that enables quick, convenient and inexpensive selection, supply and changeover of carbonated and plain water to any or all beverage dispensing valves of a beverage dispenser, without requiring disconnection, rerouting and reconnection of fluid supply hoses to the dispensing valve or significant disassembly and reassembly of the beverage dispenser. A particular advantage is that only two lines, one for carbonated and another for plain water, need be run from a cold plate to a manifold for delivery of carbonated or plain water to individual ones of the beverage dispensing valves connected to the manifold. Should a beverage dispenser have ten beverage dispensing valves and two manifolds mounting five valves each, it is necessary to run ten beverage syrup flavoring lines to the valves, but only two water lines to each manifold, one for carbonated and another plain water, for a total of fourteen lines running from the cold plate to the beverage panel. This compares favorably with conventional practice in which a total of twenty lines would be required, ten for syrup plus ten for water. The reduced number of hose connections represents considerable cost savings.

Use of the valve mounting blocks 88 is advantageous in that if affords an ability to use one part, the valve mounting block, to both hold the selection fittings 92 and 94 in place and mount the beverage valves, which reduces costs. Further, the valve mounting blocks are precisely located and serve to keep the selection fittings centered, so that seals carried by the dole fittings do not leak. Machine screws can be used to hold the valve mounting blocks to the manifold while sandwiching a sheet metal beverage panel and selection fittings in between which type of retention minimizes external forces on the beverage panel.

While embodiments of the invention have been described in detail, various modifications and other embodiments thereof may be devised by one skilled in the art without departing from the spirit and scope of the invention, as defined in the appended claims.

What is claimed is:

1. A system for selectively supplying first and second diluents to a beverage dispensing valve, comprising:
a manifold having first and second inlets for fluid coupling to sources of the first and second diluents, a first diluent outlet port for the first diluent and a second outlet port for the second diluent;
a first diluent selection fitting for coupling to said manifold first and second diluent outlet ports and to the beverage dispensing valve for delivering the first diluent from said first outlet port to the valve while closing said second outlet port; and
a second diluent selection fitting for coupling to said manifold first and second diluent outlet ports and to the beverage dispensing valve for delivering the second diluent from said second outlet port to the valve while closing said first outlet port.

2. A system as in claim 1, including means for constraining said first and second diluent selection fittings for coupling to said manifold in one orientation only.

3. A system as in claim 1, wherein:
said first diluent selection fitting has a passage and a plug and, when said first fitting is coupled with said manifold first and second outlet ports, said plug closes said second outlet port and said passage extends between an inlet to said passage at said first outlet port and an outlet from said passage for being fluid coupled to the beverage dispensing valve, and
said second diluent selection fitting has a passage and a plug and, when said second fitting is coupled with said manifold first and second outlet ports, said plug closes said first outlet port and said passage extends between an inlet to said passage at said second outlet port and an outlet from said passage for being fluid coupled to the beverage dispensing valve.

4. A system as in claim 3, wherein:
said first diluent selection fitting includes a body, first and second dole fittings on one side of said body and a third dole fitting on an opposite side of said body, said second dole fitting comprising said plug and said passage extending between said first and third dole fittings, said first and second dole fittings being respectively received in said manifold first and second outlet ports when said first fitting is coupled to said manifold outlet ports and said third dole fitting providing means for coupling said passage outlet with the beverage valve, and
said second diluent selection fitting includes a body, first and second dole fittings on one side of said body and a third dole fitting on an opposite side of said body, said first dole fitting comprising said plug and said passage extending between said second and third dole fittings, said first and second dole fittings being respectively received in said manifold first and second outlet ports when said second fitting is coupled to said manifold outlet ports and said third dole fitting providing means for coupling said passage outlet with the beverage valve.

5. A system as in claim 4, including a mounting block for mounting the beverage valve, said mounting block having a passage therethrough, said passage having an outlet for coupling with a diluent inlet to the beverage valve and an inlet for receiving said third dole fitting of one of said first and second diluent selection fittings.

6. A system as in claim 5, wherein the beverage valve is part of a beverage dispenser having a beverage panel, said manifold is on a rearward side of said beverage panel, said mounting block is on a forward side of said beverage panel, and one of said first and second fittings extends through an opening in said beverage panel between said manifold and mounting block.

7. A system for selectively supplying carbonated and plain water to a beverage dispensing valve of a beverage dispenser, said system comprising;
a manifold having carbonated and plain water inlets for fluid coupling to supplies of carbonated and plain water and carbonated and plain water outlet ports fluid coupled to said carbonated and plain water inlets;
a beverage valve mounting block having a passage, said passage having an outlet for fluid coupling with a water inlet to the beverage valve;
a carbonated water selection fitting having a first fitting for fluid coupling to said manifold carbonated water outlet port, a second fitting for coupling to and closing said manifold plain water outlet port, a third fitting for fluid coupling to an inlet to said mounting block passage, and a passage extending between said first and third fittings for flow of carbonated water from said manifold carbonated water outlet port to and through said mounting block passage to the inlet to the beverage dispensing valve; and
a plain water selection fitting having a first fitting for coupling to and dosing said manifold carbonated water outlet port, a second fitting for fluid coupling to said manifold plain water outlet port, a third fitting for fluid coupling to an inlet to said mounting block passage, and a passage extending between said second and third fittings for flow of plain water from said manifold plain water outlet port to and through said mounting block passage to the inlet to the beverage dispensing valve,
said carbonated and plain water selection fittings being interchangeable to couple the first and second fittings of one or the other of said selection fittings to said manifold carbonated and plain water outlet ports to selectively supply either carbonated or plain water to said valve mounting block passage for delivery to the beverage valve.

8. A system as in claim 7, wherein said first and second fittings of each said first and second selection fitting are dole fittings for plugging into said manifold carbonated and plain water outlet ports.

9. A system as in claim 7, wherein said third fitting of each said first and second selection fitting is a dole fitting for plugging into said mounting block passage inlet.

10. A system as in claim 7, including means for constraining said first and second selection fittings for coupling to said manifold carbonated and plain water outlet ports in one orientation only.

11. A system as in claim 7, wherein said constraining means constrains said first fitting of said carbonated water selection fitting to fluid couple only with said manifold carbonated water outlet port and constrains said second fitting of said plain water selection fitting to fluid couple only with said manifold plain water outlet port.

12. A system for selectively supplying first and second diluents to individual ones of a plurality of beverage dispensing valves, said system comprising:
a manifold having first and second diluent inlets for fluid coupling to supplies of first and second diluents and a plurality of pairs of first and second diluent outlet ports respectively fluid coupled to said first and second diluent inlets;
a plurality of first diluent selection fittings each for coupling to a selected individual one of said pairs of first and second diluent outlet ports and for fluid coupling to an associated beverage dispensing valve for delivering the first diluent from the first outlet port of the selected pair of outlet ports to the associated beverage valve while closing the second diluent outlet port of the selected pair of outlet ports; and
a plurality of second diluent selection fittings each for coupling to a selected individual one of the first and second diluent outlet ports to which first diluent selection fittings are not coupled and for fluid coupling to an associated beverage dispensing valve for delivering the second diluent from the second outlet port of the selected pair of outlet ports to the associated beverage valve while closing the first diluent outlet port of the selected pair of outlet ports.

13. A system as in claim 12, including means for constraining said first and second pluralities of fittings for coupling to said manifold in one orientation only.

14. A system as in claim 12, wherein:
each said first diluent selection fitting has a passage and a plug, such that when a first diluent selection fitting is coupled with an associated pair of manifold first and second outlet ports said plug doses the second outlet port of the associated pair and said passage extends between an inlet to said passage at the first outlet port of the associated pair and an outlet from said passage for being fluid coupled to the associated beverage dispensing valve, and
each said second diluent selection fitting has a passage and a plug, such that when a second fitting is coupled with an associated pair of manifold first and second outlet ports said plug doses the first outlet port of the associated pair and said passage extends between an inlet to said passage at the second outlet port of the associated pair and an outlet from said passage for being fluid coupled to the associated beverage dispensing valve.

15. A system as in claim 14, wherein:
each said first diluent selection fitting includes a body, first and second dole fittings on one side of said body and a third dole fitting on an opposite side of said body, said second dole fitting comprising said plug and said passage extending between said first and third dole fittings, such that when a first diluent selection fitting is coupled to an associated pair of manifold first and second outlet ports said first and second dole fittings are received in the first and second outlet ports, respectively, and said third dole fitting provides means for coupling said passage outlet to the associated beverage valve, and
each said second diluent selection fitting includes a body, first and second dole fittings on one side of said body and a third dole fitting on an opposite side of said body, said first dole fitting comprising said plug and said passage extending between said second and third dole fittings, such that when a second diluent selection fitting is coupled to an associated pair of manifold first and second outlet ports said first and second dole fittings are received in the first and second outlet ports, respectively, and said third dole fitting provides means for coupling said passage outlet to the associated beverage valve.

16. A system as in claim 15, including a plurality of mounting blocks, each for mounting an associated beverage valve and each having a passage therethrough and said passage having an outlet for coupling with a diluent inlet to the associated beverage valve and an inlet for receiving said third dole fitting of an associated one of said first and second diluent selection fittings.

17. A system as in claim 16, including a beverage panel for supporting said manifold and mounting blocks on opposite sides of said panel with first and second diluent selection fittings extending through openings in said panel between associated pairs of manifold first and second diluent outlet ports and inlets to associated mounting blocks.

18. A system as in claim 12, wherein said first and second diluents are carbonated and plain water.

19. A method of selectively supplying first and second diluents to a beverage dispensing valve, comprising the steps of:
connecting first and second diluent supplies to a manifold;
flowing the first and second diluents through the manifold to respective first and second diluent outlet ports from the manifold;
and delivering either the first or second diluent to the beverage dispensing valve by either:
coupling a first diluent selection fitting to the manifold first and second outlet ports to close the second outlet port and to establish at least a portion of a flow path for flow of the first diluent from the first outlet port to an inlet to the beverage dispensing valve; or
coupling a second diluent selection fitting to the manifold first and second outlet ports to close the first outlet port and to establish at least a portion of a flow path for the second diluent from the second outlet port to an inlet to the beverage dispensing valve.

20. A method as in claim 19, including the step of constraining each of the first and second diluent selection fittings for coupling to the manifold in one orientation only.

21. A method as in claim 19, wherein:
the first diluent selection fitting has a passage and a plug and said step of coupling the first selection fitting to the manifold first and second outlet ports comprises coupling the plug with the second outlet port to dose the second outlet port and coupling an inlet to the passage to the first outlet port for flow of the first diluent from the first outlet port through the passage, the passage providing at least the portion of the flow path for the first diluent from the first outlet port to the beverage dispensing valve, and
the second diluent selection fitting has a passage and a plug and said step of coupling the second selection fitting to the manifold first and second outlet ports comprises coupling the plug with the first outlet port to close the first outlet port and coupling an inlet to the passage to the second outlet port for flow of the second diluent from the second outlet port through the passage, the passage providing at least the portion of the flow path for the second diluent from the second outlet port to the beverage dispensing valve.

22. A method as in claim 21, including the steps of providing a mounting block, mounting the beverage dispensing valve on the mounting block, the mounting block having a passage having an inlet and an outlet, fluid coupling the manifold passage outlet to a diluent inlet to the beverage dispensing valve, and fluid coupling an outlet from the passage of one of the first and second diluent selection fittings to the manifold passage inlet for flow of one of the first and second diluents through the manifold passage and to the diluent inlet to the beverage valve.

23. A method as in claim 19, wherein said step of connecting each of a first and second diluent supply to a manifold comprises connecting each of a carbonated and plain water supply to the manifold.

24. A method of selectively supplying first and second diluents to each of a plurality of beverage dispensing valves, comprising the steps of:
fluid coupling first and second diluent supplies to respective first and second diluent inlets to a manifold having a plurality of pairs of first and second diluent outlet ports respectively fluid coupled to the first and second diluent inlets;
and selectively delivering either the first or second diluent to each of at least two beverage dispensing valves by, in connection with each of the at least two beverage dispensing valves, either:
coupling a first diluent selection fitting to an associated pair of manifold first and second outlet ports to close the second outlet port and to establish at least a portion of a flow path for the first diluent from the first outlet port to an inlet to one of the at least two beverage dispensing valves; or
coupling a second diluent selection fitting to the associated pair of manifold first and second outlet ports to dose the first outlet port and to establish at least a portion of a flow path for the second diluent from the second outlet port to an inlet to the one of the at least two beverage dispensing valves.

25. A method as in claim 24, including the step of constraining each of the first and second diluent selection fittings for coupling to the manifold in one orientation only.

26. A method as in claim 24, wherein:
the first diluent selection fitting has a passage and a plug and said step of coupling the first selection fitting to an associated pair of manifold first and second outlet ports comprises coupling the plug with the second outlet port of the associated pair to close the second outlet port and coupling an inlet to the passage to the first outlet port of the associated pair for flow of the first diluent from the first outlet port through the passage, the passage establishing at least the portion of the flow path for the first diluent from the first outlet port to the beverage dispensing valve, and
the second diluent selection fitting has a passage and a plug and said step of coupling the second selection fitting to the associated pair of manifold first and second outlet ports comprises coupling the plug with the first outlet port of the associated pair to close the first outlet port and coupling an inlet to the passage to the second outlet port of the associated pair for flow of the second diluent from the second outlet port through the passage, the passage establishing at least the portion of the flow path for the second diluent from the second outlet port to the beverage dispensing valve.

27. A method as in claim 26, including the steps of providing a mounting block for each beverage dispensing valve, mounting the beverage dispensing valves on associated individual ones of the mounting blocks, the mounting blocks having a passage having an inlet and an outlet, fluid coupling the mounting block passage outlet to a diluent inlet to the associated beverage dispensing valve, and fluid coupling outlets from the passages of associated ones of the first and second diluent selection fittings to the mounting block passage inlets for flow of the selected one of the first and second diluents through each mounting block passage and to the diluent inlet to the associated mounted beverage valve.

28. A method as in claim 24, wherein the first and second diluents are carbonated and plain water.
